(19) United States
(12) Patent Application Publication
(10) Pub. No.: US 2025/0198844 A1
(43) Pub. Date: Jun. 19, 2025

(54) OPTICAL INFORMATION TRAINING AND GENERATION APPARATUS, OPTICAL INFORMATION TRAINING AND GENERATION METHOD, AND PROGRAM

(71) Applicant: NEC Corporation, Tokyo (JP)

(72) Inventor: Tsubasa NAKAMURA, Tokyo (JP)

(73) Assignee: NEC Corporation, Tokyo (JP)

(21) Appl. No.: 18/947,495

(22) Filed: Nov. 14, 2024

(30) Foreign Application Priority Data
Dec. 14, 2023 (JP) 2023-211299

(51) Int. Cl. G01J 3/28

(52) U.S. Cl. CPC G01J 3/2823; G01J 2003/2826

(57) ABSTRACT

An optical information training and generation apparatus includes an optical information training and inference part which includes an optical training and inference section for training for information on optics with a two-dimensional image of a three-dimensional scene acquired by a sensor as teacher data, a sensor identifier input part for receiving a sensor identifier to identify the sensor, a spectral characteristic conversion part, and a spectral characteristic setting part for setting a spectral characteristic in the spectral characteristic conversion part. The spectral characteristic setting part sets a training spectral characteristic corresponding to the sensor identifier in the spectral characteristic conversion part. The optical training and inference section outputs optical information to a latter part and the spectral characteristic conversion part outputs color values based on the optical information according to the training spectral characteristic.

### REFERENCE TO RELATED APPLICATION

The present invention is based upon and claims the benefit of the priority of Japanese patent application No. 2023-211299, filed on Dec. 14, 2023, the disclosure of which is incorporated herein in its entirety by reference thereto.

The present invention relates to an optical information training and generation apparatus, an optical information training and generation method, and a program.

### BACKGROUND

The following literature relates to display a two-dimensional image of a three-dimensional scene.

PTL (Patent Literature) 1 relates to a method for reconstructing color and depth information of a scene.

PTL 1: Japanese Patent Kohyo Application No. 2021-535466A

### SUMMARY

The following analysis has been made by the present inventor.

NeRF (Neural Radiance Fields) which is a training-type three-dimensional modeling technology is explosively expanding in a wide range of fields in which three-dimensional (3D) shapes are handled. In NeRF, it is assumed that two-dimensional images of a three-dimensional scene acquired by using a single camera are supplied to as teacher images in an RGB signal format.

However, if two-dimensional images of the same scene are acquired, color tones of the acquired two-dimensional images are often different from each other because of difference between individual cameras or difference of camera types. Furthermore, in a case where a plurality of cameras are used in a mixed manner, two-dimensional images of a single three-dimensional scene which are to be identical, may have different color tones depending on cameras. In such case, because a plurality of cameras are used in a mixed manner, a precision of two-dimensional image of a three-dimensional scene generated using a trained model may be reduced. Alternatively, it becomes necessary to perform training using individual models.

It is an object of the present invention to provide an optical information training and generation apparatus, an optical information training and generation method, and a program which contribute to enable to generate two-dimensional images of the same color tone irrespective of a difference between color tones of individual cameras to be used in a case where different cameras are used when generating a two-dimensional image of a three-dimensional scene from an arbitrary viewpoint.

According to a first aspect of the present invention, there is provided an optical information training and generation apparatus, including:
an optical information training and inference part which includes an optical training and inference section for training for information on optics with a two-dimensional image of a three-dimensional scene acquired by a sensor as teacher data;
a sensor identifier input part for receiving a sensor identifier to identify the sensor;
a spectral characteristic conversion part;
a spectral characteristic setting part for setting a spectral characteristic in the spectral characteristic conversion part; wherein
the spectral characteristic setting part sets a training spectral characteristic corresponding to the sensor identifier in the spectral characteristic conversion part;
the optical training and inference section outputs optical information to a latter part; and
the spectral characteristic conversion part outputs color values based on the optical information according to the training spectral characteristic.

According to a second aspect of the present invention, there is provided an optical information training and generation method, performed by a computer of an optical information training and generation apparatus, including:
receiving a sensor identifier to identify the sensor;
setting a training spectral characteristic corresponding to the sensor identifier as a spectral characteristic;
training for information on optics with a two-dimensional image of a three-dimensional scene acquired by the sensor as teacher data;
outputting optical information to a latter part; and
outputting color values based on the optical information according to the training spectral characteristic. The present method is tied to a particular machine, namely, a computer which performs the above method.

According to a third aspect of the present invention, there is provided a program casing a computer of an optical information training and generation apparatus to perform processings of:
receiving a sensor identifier to identify the sensor;
setting a training spectral characteristic corresponding to the sensor identifier as a spectral characteristic;
training for information on optics with a two-dimensional image of a three-dimensional scene acquired by the sensor as teacher data;
outputting optical information to a latter part; and
outputting color values based on the optical information according to the training spectral characteristic.

Note, this program can be recorded in a computer-readable storage medium. The storage medium can be non-transitory one, such as a semiconductor memory, a hard disk, a magnetic recording medium, an optical recording medium, and so on. The present invention can be realized by a computer program product.

According to the present invention, it is possible to provide an optical information training and generation apparatus, an optical information training and generation method, and a program which contribute to enable to generate two-dimensional images of the same color tone irrespective of a difference between color tones of individual cameras to be used in a case where different cameras are used when generating a two-dimensional image of a three-dimensional scene from an arbitrary viewpoint.

### BRIEF DESCRIPTION OF DRAWINGS

FIG. 1 is a block diagram illustrating an example of a configuration of an optical information training and generation apparatus related to the present disclosure.

FIG. 2 is a block diagram illustrating an example of a configuration of a conventional image generation system.

FIG. 3 is a block diagram illustrating an example of a configuration of an image generation system related to the present disclosure.

FIG. 4 is a block diagram illustrating an example of a configuration of an image generation system related to the present disclosure.

FIG. 5 is a block diagram illustrating an example of a configuration of an image generation system related to the present disclosure.

FIG. 6 is a block diagram illustrating an example of a configuration of an image generation system related to the present disclosure.

FIG. 7 illustrates a configuration of a computer making up of an optical information training and generation apparatus related to the present disclosure.

### EXAMPLE EMBODIMENTS

Note, in the present disclosure, drawings are associated with one or more example embodiments. Furthermore, each example embodiment described below can appropriately be combined with other example embodiments and the present invention is not limited to each example embodiment.

First, an outline of an example embodiment of the present invention will be described with reference to drawings. Note, in the following outline, reference signs of the drawings are denoted to each element as an example for the sake of convenience to facilitate understanding and are not intended to limit the present invention thereto. Furthermore, an individual connection line between blocks in the drawings, etc., referred to in the following description includes both one-way and two-way directions. A one-way arrow schematically illustrates a principal signal (data) flow and does not exclude bidirectionality.

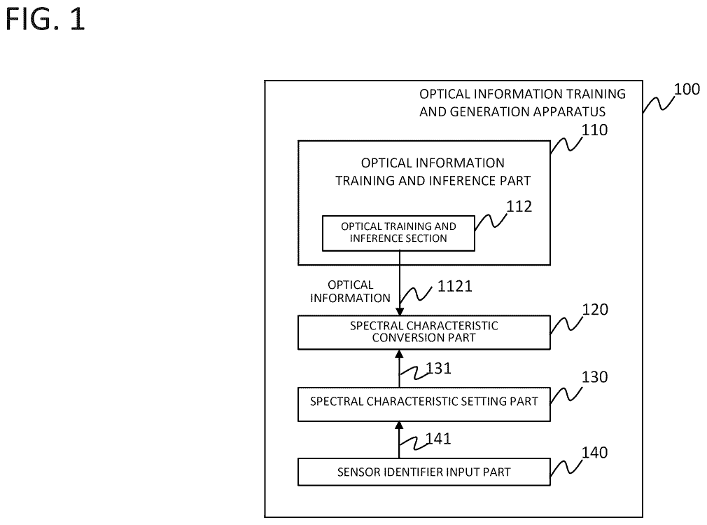

FIG. 1 is a block diagram illustrating an example of a configuration of an optical information training and generation apparatus related to the present disclosure. With reference to FIG. 1, an optical information training and generation apparatus 100 includes an optical information training and inference part 110, a spectral characteristic conversion part 120, a spectral characteristic setting part 130 for setting a spectral characteristic in the spectral characteristic conversion part 120, and a sensor identifier input part 140. The optical information training and inference part 110 includes an optical training and inference section 112 for training for information on optics with a two-dimensional image of a three-dimensional scene acquired by a sensor which is, for example, a two-dimensional camera as teacher data.

Note, in the present example embodiment, it is assumed that a spectral characteristic is, for example, a set of functions to represent light sensitivities of a red (R), a green (G), and a blue (B) with respect to light wavelengths (respectively referred to an R function, a G function, and a B function). For example, a red (R) value may be acquired by to multiplying elements of optical information corresponding wavelengths of an original light signal with light sensitivities represented by an R function and summing multiplication results, a green (G) value may be acquired by multiplying elements of optical information corresponding to wavelengths of an original light signal with light sensitivities represented by an G function and summing multiplication results, and a blue (B) value may be acquired by multiplying elements of optical information corresponding to wavelengths of an original light signal with light sensitivities represented by an B function and summing multiplication results.

The sensor identifier input part 140, for example, receives a sensor identifier to identify a sensor that is a two-dimensional camera. The spectral characteristic setting part 130 sets a training spectral characteristic corresponding to the sensor identifier in the spectral characteristic conversion part 120. The optical training and inference section 112 outputs optical information 1121 to a latter part. The spectral characteristic conversion part 120 outputs color values based on the optical information according to the training spectral characteristic. The color values are, for example, RGB values.

If different sensors are used for acquiring two-dimensional images, a spectral characteristic is set to the spectral characteristic conversion part 120 based on a sensor identifier of the sensor which has acquired the two-dimensional images. Therefore, it becomes possible to prevent from performing training with a spectral characteristic of a sensor which is different from the sensor which has acquired the two-dimensional images. When two-dimensional images are generated by using an inference spectral characteristic at the time of inference, it is possible to generate two-dimensional images of the same color tone irrespective of a difference of color tone between individual cameras being used.

According to the example embodiment, it is possible to provide an optical information training and generation apparatus, an optical information training and generation method, and a program which contribute to enable to generate two-dimensional images of the same color tone irrespective of a difference of color tone between individual cameras to be used when generating a two-dimensional image of a three-dimensional scene from an arbitrary viewpoint.

### First Example Embodiment

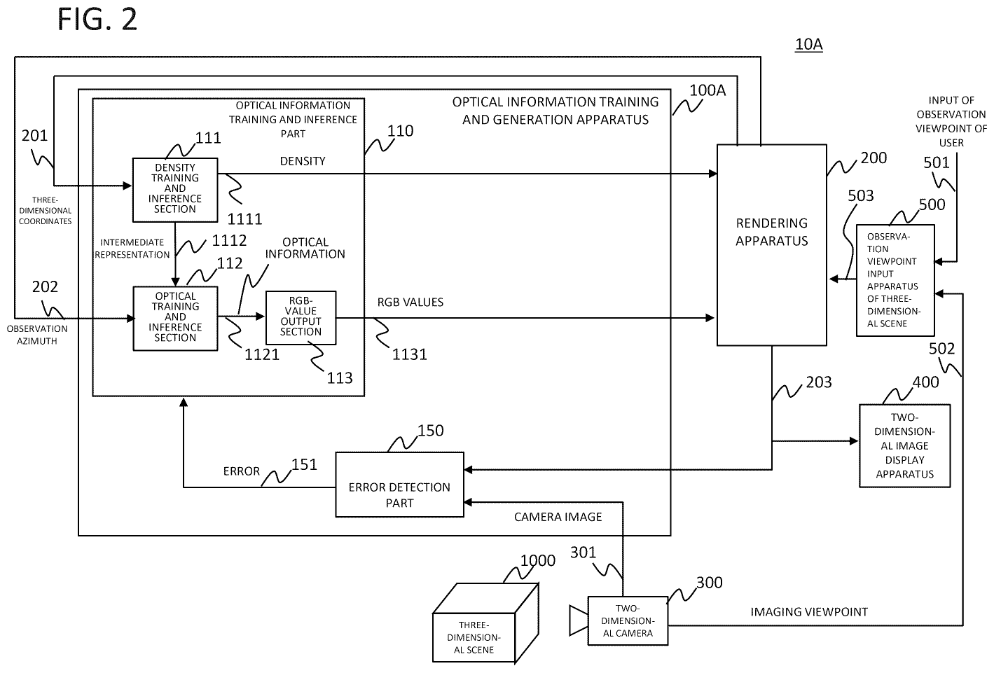

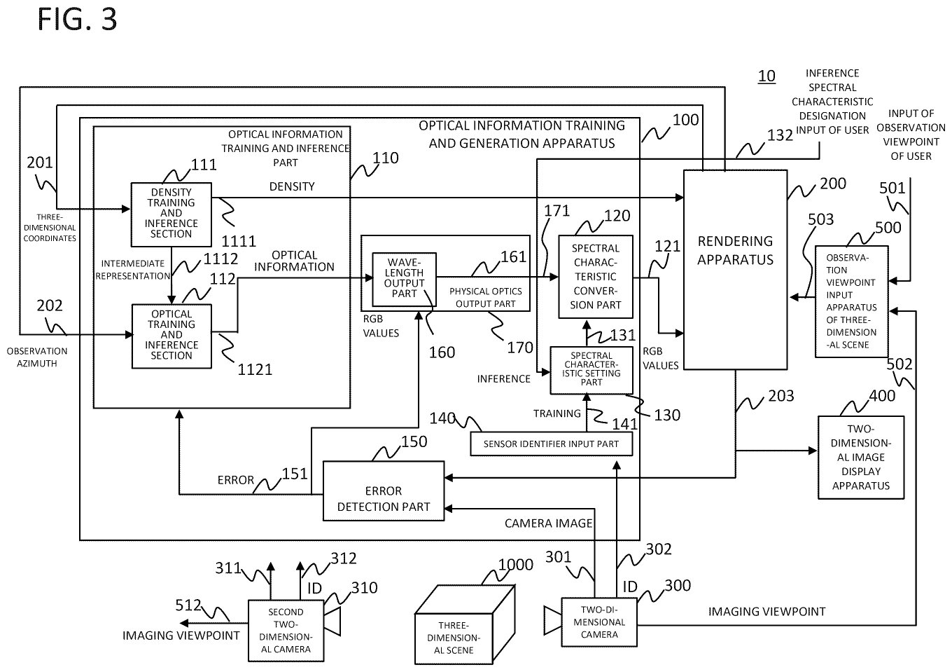

Next, a first example embodiment will be described with reference to drawings in detail. FIG. 3 is a block diagram illustrating an example of a configuration of an image generation system related to the present disclosure. Furthermore, FIG. 2 is a block diagram illustrating an example of a configuration of a conventional image generation system. With reference to FIG. 2, a conventional image generation system 10A includes an optical information training and generation apparatus 100A, a rendering apparatus 200, a two-dimensional camera (also referred to as a sensor) 300, a two-dimensional image display apparatus 400, and an observation viewpoint input apparatus 500 of a three-dimensional scene. The two-dimensional camera 300 acquires a two-dimensional image of a three-dimensional scene 1000.

First, examples of operations of training and inference of a conventional optical information training and generation system 10A will be described. At the time of training of the conventional optical information training and generation system 10A, the optical information training and generation apparatus 100A performs training for a spatial structure and information on optics with a two-dimensional image of a three-dimensional scene acquired by a two-dimensional camera 300 as teacher data using an optical information training and inference part 110 and an error detection part 150. Note, although the two-dimensional camera 300 is connected through a line with an error detection part 150, the two-dimensional camera 300 is not necessarily to be connected directly to the error detection part 150. It is sufficient to have a configuration in which images shot by the two-dimensional camera 300 are supplied to the error detection part 150.

An optical information training and inference part 110 includes a density training and inference section 111, an optical training and inference section 112 and an RGB-value output section 113. As an example, from the rendering apparatus 200, three-dimensional coordinates 201 are supplied to the density training and inference section 111 and an observation azimuth 202 is supplied to the optical training and inference section 112. The density training and inference section 111 outputs a density 1111 to the rendering apparatus 200 and outputs an intermediate representation 1112 which represents the spatial structure to the optical training and inference section 112. The optical training and inference section 112 receives an observation azimuth 202 and an intermediate representation 1112 and outputs optical information 1121. The RGB-value output section 113 converts the optical information 1121 to RGB values (also referred to as color values) 1131 to output to the rendering apparatus 200. The rendering apparatus 200 renders a two-dimensional image 203 based on the density 1111 and the RGB values to output. Note, a fixed spectral characteristic, for example, a spectral characteristic of the two-dimensional camera 300 is set to the RGB-value output section 113, but not limited thereto. Note, the density training and inference section 111 is a subordinated concept of an intermediate representation training and inference section which performs training and inference for an intermediate representation. Any configuration is possible as long as a configuration for outputting an intermediate representation 1112.

An imaging viewpoint 502 of the two-dimensional camera 300 is supplied to an observation viewpoint input apparatus 500 of a three-dimensional scene and supplied to the rendering apparatus 200 as an observation viewpoint 503. The rendering apparatus 200 outputs three-dimensional coordinates 201 and an observation azimuth 202 to the optical information training and inference part 110 based on the observation viewpoint 503. Note, in this disclosure, although it is described that the rendering apparatus 200 includes a rendering function of a two-dimensional image 203 and a control function to output three-dimensional coordinates 201 and an observation azimuth 202 to the optical information training and inference part 110, it may be configured that the control function to output three-dimensional coordinates 201 and an observation azimuth 202 to the optical information training and inference part 110 may be performed by a control apparatus different from the rendering apparatus 200.

The error detection part 150 detects an error between a two-dimensional image 203 rendered by the rendering apparatus 200 and a two-dimensional image of a three-dimensional scene acquired by the two-dimensional camera (also referred to camera image) 301. The optical information training and inference part 110 generates a trained model by adjusting parameters of the density training and inference section 111 and parameters of the optical training and inference section 112 based on an error 151 outputted by the error detection part 150. The generated trained model includes a first trained model in the density training and inference section 111 and a second trained model in the optical training and inference section 112.

Next, an example of operation at the time of inference of the conventional image generation system 10A will be described. At the time of inference of the conventional image generation system 10A, as an example, an observation viewpoint 501 of a user of the three-dimensional scene 1000 is supplied to an observation viewpoint input apparatus 500 of the three-dimensional scene and inputted to the rendering apparatus 200 as an observation viewpoint 503. The rendering apparatus 200 outputs three-dimensional coordinates 201 and an observation azimuth 202 to trained model generated as described above, based on the observation viewpoint 503.

Using three-dimensional coordinates and an observation azimuth of a three-dimensional scene 1000 generated based on the observation viewpoint 503 of a user of the three dimensional scene supplied by the rendering apparatus 200 as an input, a second trained model in the optical training and inference section 112 outputs optical information 1121 and the RGB-value output section 113 converts the optical information 1121 to RGB values 1131 to output to the rendering apparatus 200. On the other hand, a density 1111 is supplied to the rendering apparatus 200 from the first trained model in the density training and inference section 111. The rendering apparatus 200 renders a two-dimensional image of the three-dimensional scene 1000 observed from the observation viewpoint 501 of the user based on the density 1111 and the RGB values 1131 to output to a two-dimensional image display apparatus 400. The two-dimensional image display apparatus 400 displays the two-dimensional image 203 of the three-dimensional scene 1000 observed from the observation viewpoint 501 of the user.

Next, a configuration and an operation of an image generation system according to a first example embodiment will be described with reference to FIG. 3. The first example embodiment is an example in which a two-dimensional camera (sensor) 300 and a second two-dimensional camera 310 are used. It is assumed that color tones of the two-dimensional camera 300 and the second two-dimensional camera 310 are different. Note, in FIG. 3, the same components as those in FIG. 2 are denoted by the same reference signs and the description thereof will be omitted.

With reference to FIG. 3, an image generation system 10 includes an optical information training and generation apparatus 100, a rendering apparatus 200, a two-dimensional camera (also referred to as a sensor) 300, a two-dimensional image display apparatus 400, an observation viewpoint input apparatus 500 of a three-dimensional scene, and a second two-dimensional camera 310. The two-dimensional camera 300 and the second two-dimensional camera 310 acquire two-dimensional images of the three-dimensional scene 1000. Note, in the present disclosure, although it is described that the rendering apparatus 200 includes a rendering function of a two-dimensional image 203 and a control function to output three-dimensional coordinates 201 and an observation azimuth 202 to the optical information training and inference part 110, it may be configured that the control function to output three-dimensional coordinates 201 and an observation azimuth 202 to the optical information training and inference part 110 may be performed by a control apparatus different from the rendering apparatus 200.

The optical information training and generation apparatus 100 of the image generation system 10 includes an optical information training and inference part 110, a spectral characteristic conversion part 120, a spectral characteristic setting part 130 for setting a spectral characteristic to the spectral characteristic conversion part 120, a sensor identifier input part 140, an error detection part 150, and a physical optics output part 170 including a wavelength output part 160. The optical information training and inference part 110 and the error detection part 150 are the same as the optical information training and inference part 110 and the error detection part 150 of the optical information training and generation apparatus 100A of the conventional image generation system 10A as shown in FIG. 2. Furthermore, it is assumed that the second two-dimensional camera 310 is different from the second two-dimensional in color tone.

Next, an example of a training operation of the first example embodiment will be described with reference to the image generation system 10 related to the present disclosure as shown in FIG. 3.

A difference between the training operation of the image generation system 10 related to the present disclosure as shown in FIG. 3 and the training operation of the conventional image generation system 10A as shown in FIG. 2 is below.

At the time of the training of the image generation system 10 related to the present disclosure as shown in FIG. 3, for example, the sensor identifier input part 140 receives a sensor identifier ID302 to identify the two-dimensional camera (sensor) 300 from the two-dimensional camera 300 to output it to the spectral characteristic setting part 130 as a sensor identifier ID141. The spectral characteristic setting part 130 sets a training spectral characteristic corresponding to the sensor identifier ID302 in the spectral characteristic conversion part 120 according to the sensor identifier ID141. Note, although the two-dimensional camera 300, the error detection part 150 and the sensor identifier input part 140 are connected with lines, the two-dimensional camera 300, the error detection part 150 and the sensor identifier input part 140 are not necessarily to be connected directly. It is sufficient to have a configuration in which images shot by a wo-dimensional camera 300 and a sensor identifier (ID) are supplied to an error detection part 150 and a sensor identifier input part 140. Note, the imaging viewpoint 502 of the two-dimensional camera 300 is supplied to an observation viewpoint input apparatus 500 of the three-dimensional scene.

Furthermore, in a case where an image 311 acquired by a second two-dimensional camera 310 having a color tone different from the two-dimensional camera 300 is used, for example, the image 311 acquired by the second two-dimensional camera 310 is supplied to the error detection part 150. Furthermore, a sensor identifier ID 312 of the second two-dimensional camera 310 is supplied to the sensor identifier input part 140 and the sensor identifier input part 140 outputs it as a sensor identifier ID141 to the spectral characteristic setting part 130. The spectral characteristic setting part 130 sets a training spectral characteristic corresponding to the sensor identifier ID 312 to the spectral characteristic conversion part 120 according to the sensor identifier ID141. Note, in a case where the second two-dimensional camera 310 is used, an observation viewpoint 512 of the second two-dimensional camera 310 is supplied to the observation viewpoint input apparatus 500 of the three-dimensional scene.

The spectral characteristic conversion part 120 converts the optical information 1121 to the RGB values (also referred to as color values) 121 according to the training spectral characteristic corresponding to the sensor identification ID141 being set to output to the rendering apparatus 200. The rendering apparatus 200 renders a two-dimensional image 203 based on the density 1111 and the RGB values 121 to output.

The wavelength output part 160 of the physical optics output part 170 converts the optical information 1121 outputted from the optical training and inference section 112 of the optical information training and inference part 110 to a wavelength vector 161 to output to the spectral characteristic conversion part 120 as an output 171 of the physical optics output part 170. The wavelength vector 161 includes levels for each wavelength of a light as vector elements. Note, elements of the wavelength vector 161 are most appropriate when they are arranged in a wavelength order because of a high calculation efficiency. For example, when convolutional operations are performed, it is possible to operate efficiently because effects of physically near wavelength elements can appropriately be reflected. However, the elements are not necessarily arranged in a wavelength order. It is possible to operate in a case where respective elements of a wavelength vector correspond to the spectral characteristic conversion part 120 arranged at a latter part. Furthermore, a unit of an element of a wavelength vector may not be a wavelength. According to an application field, it may be replaced with an appropriate expression which represents a color or a spectrum. For example, because a reciprocal of a wavelength or a frequency can be mathematically handled in the same manner, those expressions may be employed.

The wavelength output part 160 includes a neural network, at a time of training, receives an error outputted from the error detection part 150 described with reference to FIG. 2 and generates a physical optics output model by adjusting parameters of the neural network. The generated physical optics output model converts the optical information 1121 to a wavelength vector 161 which includes levels for each wavelength of a light as vector elements, that is, a wavelength spectrum. The spectral characteristic conversion part 120 generates levels for each wavelength of a light outputted from the wavelength output part 160 according to the set spectral characteristic, that is, generates RGB values (color values) 121 from the wavelength vector 161.

That is, in the first example embodiment, the optical information 1121 are converted to the wavelength vector 161, and for the wavelength vector 161, the converted RGB values 121 by the spectral characteristic conversion part 120 in which a training spectral characteristic is set are supplied to the rendering apparatus 200. Note, in the first example embodiment, it is assumed that a spectral characteristic is a set of functions to represent light sensitivities of a red (R), a green (G), and a blue (B) with respect to light wavelengths (for example, respectively referred to as an R function, a G function, and a B function). That is, it is assumed that a red (R) value is acquired by multiplying elements of a wavelength vector 161 corresponding to wavelengths of an original light signal with light sensitivities represented by an R function and summing multiplication results, a green (G) value is acquired by multiplying elements of a wavelength vector 161 corresponding to wavelengths of an original light signal with light sensitivities represented by an G function and summing multiplication results, and a blue (B) value is acquired by multiplying elements of a wavelength vector 161 corresponding to wavelengths of an original light signal with light sensitivities represented by an B function and summing multiplication results.

The training operation at the time of training of the image generation system 10 related to the present disclosure as shown in FIG. 3 is the same as the training operation of the conventional image generation system 10A described with reference to FIG. 2 with the exception that the wavelength vector 161 outputted from the wavelength output part 160 is sent to the spectral characteristic conversion part 120 as the output 171 of the physical optics output part 170, and during the training, the physical optics output part 170 receives the error outputted from the error detection part 150 and adjusts parameters of the neural network in the wavelength output part 160 to generate the physical optics output model.

That is, in the same way of the operation of training of the conventional image generation system 10A as described with reference to FIG. 2, at the time of training of the image generation system 10 related to the present disclosure shown in FIG. 3, the optical information training and inference part 110 generates a trained model by adjusting parameters of the density training and inference section 111 and parameters of the optical training and inference section 112 based on an error 151 outputted by the error detection part 150. The generated trained model includes a first trained model in the density training and inference section 111 and a second trained model in the optical training and inference section 112.

Next, an operation at the time of inference of the first example embodiment will be described with reference to FIG. 3.

A difference between the operation at the time of inference of the conventional image generation system 10A as shown in FIG. 2 and an operation at the time of inference of the image generation system 10 related to the present disclosure shown in FIG. 3 are below.

The different points of the operation at the time of inference of the image generation system 10 related to the present disclosure shown in FIG. 3 is that an optical information 1121 is converted to a wavelength vector 161 by the physical optics output model in the wavelength output part 160 of the physical optics output part 170 and the wavelength vector 161 is sent to the spectral characteristic conversion part 120 as an output 171 of the physical optics output part 170. With the exception of the points as described above, the operation is the same as the inference operation of the conventional image generation system 10A described with reference to FIG. 2.

That is, in the image generation system 10 related to the present disclosure as shown in FIG. 3, the spectral characteristic setting part 130 sets an inference spectral characteristic to the spectral characteristic conversion part 120 according to the inference spectral characteristic designation input 132 of a user. Note, an inference spectral characteristic may be, for example, a fixed ideal spectral characteristic. The second trained model in the optical training and inference section 112 receives an observation azimuth and three-dimensional coordinates of a three-dimensional scene generated based on an observation viewpoint 503 of a user of the three-dimensional scene supplied from the rendering apparatus 200 and outputs optical information 1121, the physical optics output model in the wavelength output part 160 of the physical optics output part 170 converts the optical information 1121 to a wavelength vector 161, and the wavelength vector 161 is sent to the spectral characteristic conversion part 120 as an output 171 of the physical optics output part 170. The spectral characteristic conversion part 120 to which the inference spectral characteristic is set converts the output 171 to RGB values (also referred to as color values) 121 to output to the rendering apparatus 200.

Then, at the time of the inference of the image generation system 10 related to the present disclosure as shown in FIG. 3, the rendering apparatus 200 renders a two-dimensional image of the three-dimensional scene 1000 observed from the observation viewpoint 503 of the user to output to the two-dimensional image display apparatus 400, in the same way as the operation at the time of inference of the conventional image generation system 10A as shown in FIG. 2. The two-dimensional image display apparatus 400 displays the two-dimensional image of the three-dimensional scene observed from the observation viewpoint 501 of the user.

In the first example embodiment, at the time of training, the spectral characteristic setting part 130 sets a training spectral characteristic corresponding to an sensor identification ID to the spectral characteristic conversion part 120 and the training is performed, whereby the optical information 1121 obtained from a two-dimensional image acquired from the same imaging viewpoint of a three-dimensional scene can make identical even if a color tone of the two-dimensional camera (sensor) 300 and a color tone of the second two-dimensional camera (sensor) 310 are different from each other. Furthermore, at the time of inference, by setting an inference spectral characteristic to the spectral characteristic conversion part 120 to perform inference and by using arbitrary spectral characteristic as the inference spectral characteristic, it is possible to generate a two-dimensional image according to the inference spectral characteristic irrespective of the color tone of the two-dimensional camera (sensor) 300 or the color tone of the second two-dimensional camera (sensor) 310 at the time of shooting for acquiring a two-dimensional image of a three-dimensional scene.

As described above, according to the first example embodiment, it is possible to display a two-dimensional image of a three-dimensional scene 1000 observed from an observation viewpoint 501 of a user according to an inference spectral characteristic irrespective of a difference between color tones of cameras to be used in a case where different two-dimensional cameras (sensors) are used.

As described above, according to the first example embodiment, it is possible to provide an optical information training and generation apparatus, an optical information training and generation method, and a program which contribute to enable to generate two-dimensional images of the same color tone irrespective of a difference between color tones of individual cameras to be used in a case where different cameras are used when generating a two-dimensional image of a three-dimensional scene from an arbitrary viewpoint.

Note, in NeRF, it is currently not assumed to expand types of cameras, and for example, an IR (Infrared) camera, a spectroscopic camera, a LiDAR (Light Detection and Ranging) camera, and so on cannot be used. According to the first example embodiment, in a case where, for example, an IR (Infrared) camera, a spectroscopic camera, a LiDAR (Light Detection and Ranging) camera, and so on are used, a spectral characteristic of an IR (Infrared) camera, a spectroscopic camera, a LiDAR (Light Detection and Ranging) camera, and so on may be set as a training spectral characteristic.

Furthermore, it is possible to set, as an inference spectral characteristic, a spectral characteristic of a different type of camera from the camera for which a training spectral characteristic is set. For example, in a case where optical camera is used for training, a spectral characteristic of an optical camera is set as a training spectral characteristic to perform training, and at the time of inference, a spectral characteristic of an IR (Infrared) camera, a spectroscopic camera, a LiDAR (Light Detection and Ranging) camera, and so on may be set as an inference spectral characteristic.

### Second Example Embodiment

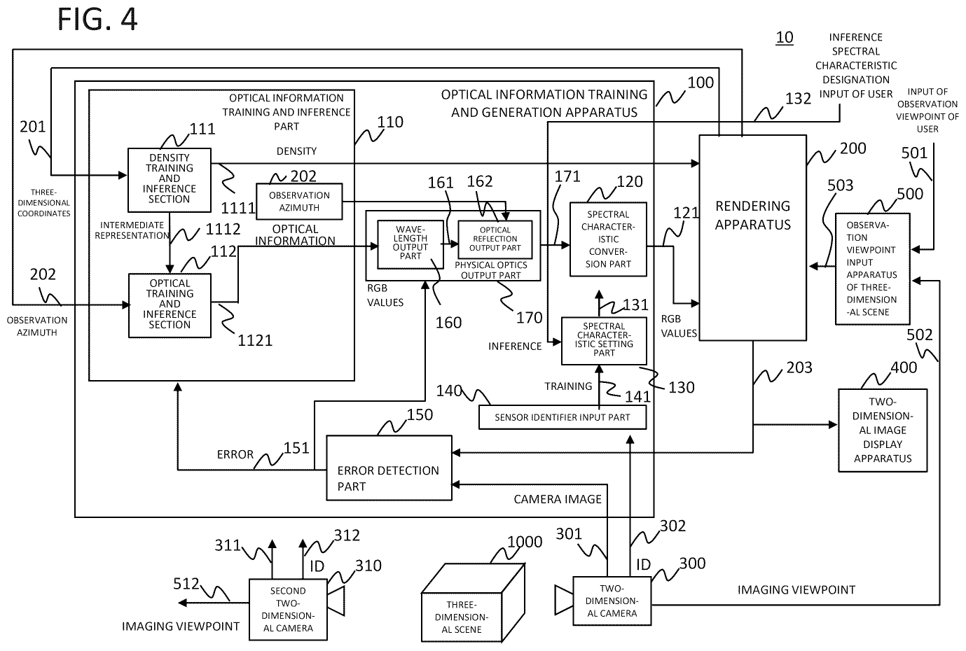

Next, a second example embodiment will be described in detail with reference to drawings. FIG. 4 is a block diagram illustrating an example of a configuration of an image generation system related to the present disclosure. FIG. 4 represents an example of a configuration in which an optical reflection output part 162 is arranged in a physical optics output part 170 in the example of the configuration of the image generation system related to the present disclosure as shown in FIG. 3. In FIG. 4, the same components as those in FIG. 3 are denoted by the same reference signs.

In FIG. 4, an observation azimuth 202 in the optical information training and inference part 110 is supplied from the rendering apparatus 200 which is the same as the observation azimuth 202 supplied to the optical training and inference section 112 and the observation azimuth 202 and an output of the wavelength output part 160 are supplied to the optical reflection output part 162.

The optical reflection output part 162 adds an incident angle and a reflection angle to each spectrum of one-dimensional wavelength vector based on the observation azimuth 202 to generate a three-dimensional wavelength vector which is then outputted to the spectral characteristic conversion part 120 as an output 171 of the physical optics output part 170. That is, the physical optics output part 170 includes an optical reflection output part 162 including a function to convert a light into a light reflection model (BRDF, Bidirectional Reflectance Distribution Function). Note, an angular distribution of BRDF may be held by approximation as coefficients of aspherical harmonics.

The training operation at the time of training is the same as the training operation of the first example embodiment described with reference to FIG. 3 with the exception that the optical reflection output part 162 adds an incident angle and a reflection angle to the wavelength vector 161 outputted from the wavelength output part 160 to acquire a three-dimensional wavelength vector to output to the spectral characteristic conversion part 120 as the output 171 of the physical optics output part 170. Furthermore, the operation at the time of inference is the same as the inference operation of the first example embodiment described with reference to FIG. 3 with the exception that the optical reflection output part 162 adds an incident angle and a reflection angle to the wavelength vector 161 outputted from the wavelength output part 160 to acquire a three-dimensional wavelength vector to output to the spectral characteristic conversion part 120 as the output 171 of the physical optics output part 170.

Therefore, according to the second example embodiment, it is possible to provide an optical information training and generation apparatus, an optical information training and generation method, and a program which contribute to enable to generate two-dimensional images of the same color tone irrespective of a difference between color tones of individual cameras to be used and by taking an incident angle and a reflection angle into account in a case where different cameras are used when generating a two-dimensional image of a three-dimensional scene from an arbitrary viewpoint.

### Third Example Embodiment

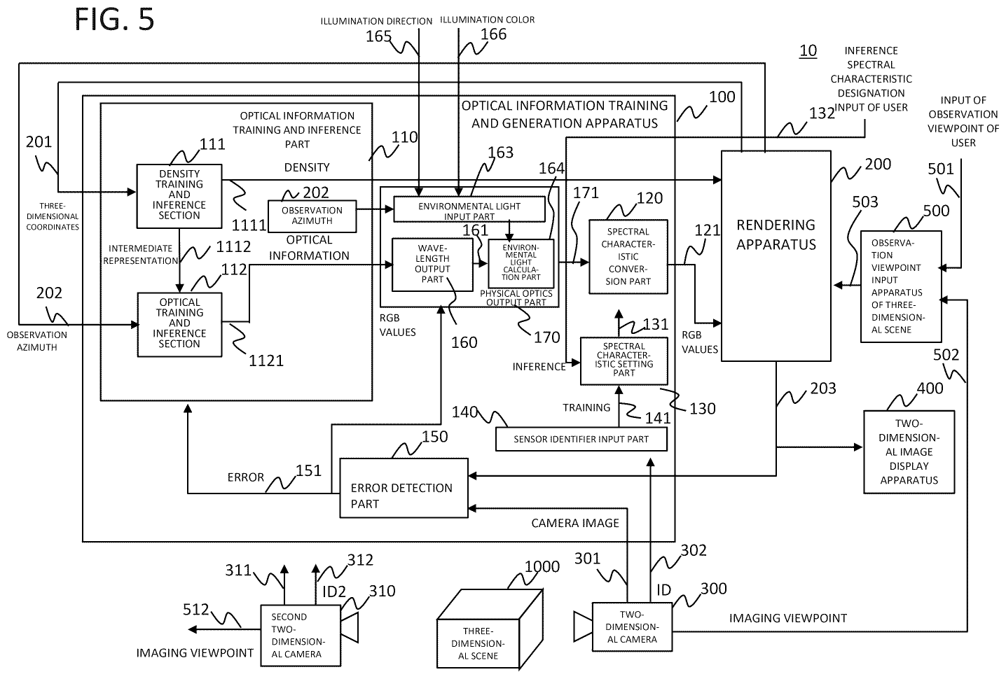

Next, a third example embodiment will be described in detail with reference to drawings. FIG. 5 is a block diagram illustrating an example of a configuration of an image generation system related to the present disclosure. FIG. 5 represents an example of a configuration in which an environmental light input part 163 and an environmental light calculation part 164 are arranged in a physical optics output part 170 in the example of the configuration of the image generation system related to the present disclosure as shown in FIG. 3. In FIG. 5, the same components as those in FIG. 3 are denoted by the same reference signs. The third example embodiment will be described with reference to the example of a configuration of an image generation system related to the present disclosure as shown in FIG. 5.

In FIG. 5, an observation azimuth 202 in the optical information training and inference part 110 is supplied from the rendering apparatus 200 which is the same as the observation azimuth 202 supplied to the optical training and inference section 112 and the observation azimuth 202 is supplied to the environmental light input part 163 of the physical optics output part 170.

The environmental light input part 163 is supplied with an environmental light azimuth (illumination direction 165 and illumination color 166), and the wavelength vector 161 outputted from the physical optics output part 170 and an output of the environmental light input par 163 are sent to the environmental light calculation part 164. The wavelength vector including the environmental light azimuth calculated by the environmental light calculation part 164 is outputted to the spectral characteristic conversion part 120 as an output 171 of the physical optics output part 170. Note, the environmental light input part 163 or the environmental light calculation part 164 may have a training function or an inference function therein.

The training operation at the time of training of the third example embodiment is the same as the training operation of the first example embodiment described with reference to FIG. 3 with the exception that the wavelength vector 161 outputted from the wavelength output part 160 and an output of the environmental light input part 163 are sent to the environmental light calculation part 164 and a wavelength vector including the environmental light azimuth calculated by the environmental light calculation part 164 is outputted to the spectral characteristic conversion part 120 as an output 171 of the physical optics output part 170. Furthermore, the operation at the time of inference is the same as the inference operation of the first example embodiment described with reference to FIG. 3 with the exception that a wavelength vector including the wavelength vector 161 outputted from the wavelength output part 160 and the environmental light azimuth calculated by the environmental light calculation part 164 is outputted to the spectral characteristic conversion part 120 as an output 171 of the physical optics output part 170.

Therefore, according to the third example embodiment, it is possible to provide an optical information training and generation apparatus, an optical information training and generation method, and a program which contribute to enable to generate two-dimensional images of the same color tone irrespective of a difference between color tones of individual cameras to be used and by taking an environmental light azimuth (illumination direction and illumination color) into account in a case where different cameras are used when generating a two-dimensional image of a three-dimensional scene from an arbitrary viewpoint.

### Fourth Example Embodiment

Next, a fourth example embodiment will be described in detail with reference to drawings. In the first to third example embodiments as shown in FIGS. 3 to 5, the spectral characteristic is designated by an identifier ID of a two-dimensional camera to the spectral characteristic conversion part 120.

In contrast, it is possible to generate a trained spectral characteristic conversion model by making up a spectral characteristic conversion part 120 by a neural network, acquiring a real wavelength vector (wavelength spectrum) of a camera image shot by a two-dimensional camera 300 to input to the neural network of the spectral characteristic conversion part 120, training coefficients of the neural network in such way that a difference between an output image of the neural network of the spectral characteristic conversion part 120 and the camera image (correct data) shot by the two-dimensional camera becomes disappeared.

A spectral characteristic equal to a spectral characteristic of the two-dimensional camera is acquired by training for camera images. At the time of training of the first to third example embodiments, a trained spectral characteristic conversion model may be set to the spectral characteristic conversion part 120 as a spectral characteristic of a two-dimensional camera to be used.

As described above, according to the fourth example embodiment, it is possible to acquire a spectral characteristic of a two-dimensional camera by training.

### Fifth Example Embodiment

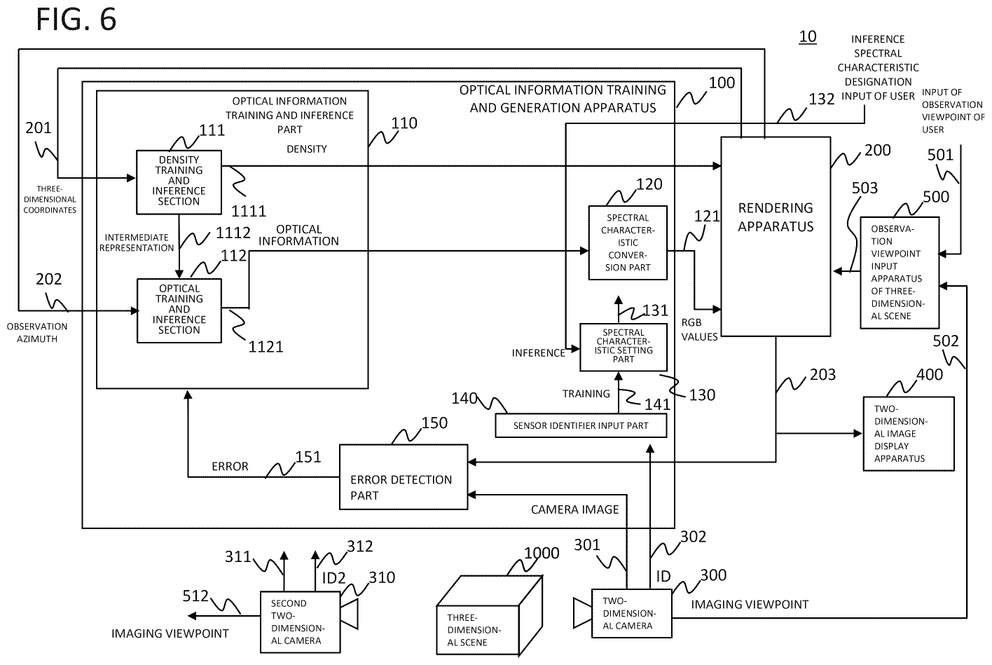

Next, a fifth example embodiment will be described in detail with reference to drawings. FIG. 6 is a block diagram illustrating an example of a configuration of an image generation system related to the present disclosure. In FIG. 6, the same components as those in FIG. 3 are denoted by the same reference signs and the description thereof may be omitted. A point of the fifth example embodiment is that a physical optics output part 170 including a wavelength output part 160 is removed from the first example embodiment and optical information 1121 outputted from an optical training and inference section 112 of an optical information training and inference part 110 is supplied to a spectral characteristic conversion part 120. Other configuration is the same as the configuration of the image generation system as shown in FIG. 3.

In the first example embodiment, the optical information 1121 is converted into a wavelength vector 161 by the wavelength output part 160 of the physical optics output part 170 to be inputted to the spectral characteristic conversion part 120. In contrast, an operation at the time of training of the fifth embodiment is performed in such way that the optical information 1121 is directly inputted to the spectral characteristic conversion part 120 without going through the physical optics output part 170.

Accordingly, the operation at the time of inference of the fifth example embodiment is the same as that at the time of inference of the first example embodiment with the exception that the optical information 1121 is inputted to the spectral characteristic conversion part 120.

According to the fifth example embodiment, it is possible to provide an optical information training and generation apparatus, an optical information training and generation method, and a program which contribute to enable to generate two-dimensional images of the same color tone irrespective of a difference between color tones of individual cameras to be used and by taking an environmental light azimuth into account in a case where different cameras are used when generating a two-dimensional image of a three-dimensional scene from an arbitrary viewpoint.

### Sixth Example Embodiment

Next, a sixth example embodiment will be described in detail with reference to drawings. In block diagrams showing examples of configurations of image generation systems related to the present disclosure as shown in FIGS. 4 and 5, it is described configurations in which the physical optics output part 170 includes the wavelength output part 160. However, in the sixth example embodiment, as in the same way as the configuration described in the block diagram showing the example of the configuration of the image generation system related to the present disclosure of FIG. 6, in FIGS. 4 and 5, a wavelength output part 160 of a physical optics output part 170 is removed, and it is configured that the optical information 1121 is supplied to the optical reflection output part 162 and the optical information 1121 is also supplied to the environmental light calculation part 164.

Therefore, according to the sixth example embodiment, it is possible to provide an optical information training and generation apparatus, an optical information training and generation method, and a program which contribute to enable to generate two-dimensional images of the same color tone irrespective of a difference between color tones of individual cameras to be used and by taking an environmental light azimuth into account in a case where different cameras are used when generating a two-dimensional image of a three-dimensional scene from an arbitrary viewpoint.

The example embodiments of the present invention have been described as above, however, the present invention is not limited thereto. Further modifications, substitutions, or adjustments can be made without departing from the basic technical concept of the present invention. For example, the configurations of the network and the elements and the representation modes of the message or the like illustrated in the individual drawings are merely used as examples to facilitate the understanding of the present invention. Thus, the present invention is not limited to the configurations illustrated in the drawings. In addition, “A and/or B” in the following description signifies at least one of A or B.

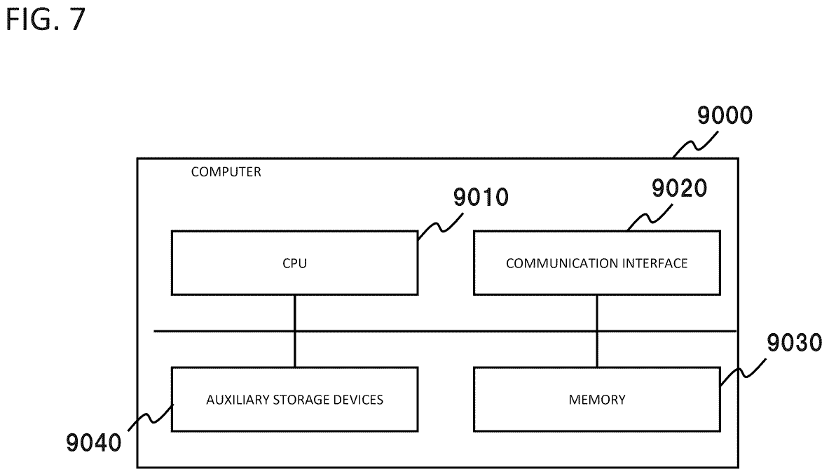

Further, the procedures described in the first to sixth example embodiment above can be realized by a program causing a computer (9000 in FIG. 7) that functions as the optical information training and generation apparatus according to the present invention to realize the functions of the optical information training and generation apparatus. FIG. 7 illustrates, as an example, such a computer configured to comprise a CPU (Central Processing Unit) 9010, a communication interface 9020, a memory 9030, and an auxiliary storage device 9040. In other words, the CPU 9010 in FIG. 7 executes the control program of the optical information training and generation apparatus, to update each calculation parameter held by the auxiliary storage device 9040, and so on.

The memory 9030 is a RAM (Random-Access-Memory) or a ROM (Read-Only Memory), and so on.

Namely, an individual part (processing means, function) of the optical information training and generation apparatus according to the above first to sixth example embodiments may be realized by a computer program that causes a processor of a computer to perform the corresponding processing described above by using its hardware.

Finally, suitable modes of the present invention will be summarized.

### [Mode 1]

An optical information training and generation apparatus may comprise an optical information training and inference part which includes an optical training and inference section for training for information on optics with a two-dimensional image of a three-dimensional scene acquired by a sensor as teacher data.

The optical information training and generation apparatus may comprise a sensor identifier input part for receiving a sensor identifier to identify the sensor.

The optical information training and generation apparatus may comprise a spectral characteristic conversion part.

The optical information training and generation apparatus may comprise a spectral characteristic setting part for setting a spectral characteristic in the spectral characteristic conversion part.

It is preferable that the spectral characteristic setting part of the optical information training and generation apparatus sets a training spectral characteristic corresponding to the sensor identifier in the spectral characteristic conversion part.

It is preferable that the optical training and inference section of the optical information training and generation apparatus outputs optical information to a latter part.

It is preferable that the spectral characteristic conversion part of the optical information training and generation apparatus outputs color values based on the optical information according to the training spectral characteristic.

### [Mode 2]

The optical information training and generation apparatus according to mode 1 may further comprises a physical optics output part including a wavelength output part for converting the optical information into a wavelength vector, In the optical information training and generation apparatus according to mode 1, it is preferable that the spectral characteristic conversion part outputs the color values based on the optical information by converting the wavelength vector outputted from the wavelength output part into the color values to output.

### [Mode 3]

In the optical information training and generation apparatus according to mode 1 or 2, it is preferable that an observation azimuth and three-dimensional coordinates of the three-dimensional scene generated based on an imaging viewpoint for the two-dimensional image of the three-dimensional scene acquired by the sensor are inputted to the optical information training and inference part

The optical information training and generation apparatus according to mode 1 or 2 may further comprise an error detection part which detects an error between a two-dimensional image rendered using the color values outputted by the spectral characteristic conversion part based on the observation azimuth and the three-dimensional coordinates, and the two-dimensional image of the three-dimensional scene acquired by the sensor.

In the optical information training and generation apparatus according to mode 1 or 2, it is preferable that the optical information training and inference part adjusts parameters of the optical training and inference section based on the error outputted by the error detection part to generate a trained model.

### [Mode 4]

In the optical information training and generation apparatus according to mode 3, it is preferable that the spectral characteristic setting part sets an inference spectral characteristic in the spectral characteristic conversion part. In the optical information training and generation apparatus according to mode 3, it is preferable that the trained model receives an observation azimuth and three-dimensional coordinates of the three-dimensional scene generated based on an inputted observation viewpoint of a user of the three-dimensional scene and outputs the optical information.

In the optical information training and generation apparatus according to mode 3, it is preferable that the spectral characteristic conversion part outputs color values based on the optical information according to the inference spectral characteristic.

### [Mode 5]

In the optical information training and generation apparatus according to mode 4, it is preferable that the spectral characteristic setting part sets an inference spectral characteristic among a plurality of inference spectral characteristics in the spectral characteristic conversion part.

### [Mode 6]

In the optical information training and generation apparatus according to mode 2, it is preferable that the physical optics output part comprises an optical reflection output part which has a conversion function of a light to an optical reflection model (BRDF (Bidirectional Reflectance Distribution Function)).

### [Mode 7]

In the optical information training and generation apparatus according to mode 2, it is preferable that the physical optics output part comprises an environmental light input part and an environmental light calculation part.

### [Mode 8]

In the optical information training and generation apparatus according to mode 1, it is preferable that the spectral characteristic conversion part comprises a training function and performs training for a sensor response characteristic of the sensor.

### [Mode 9]

An optical information training and generation method, performed by a computer of an optical information training and generation apparatus, may comprise receiving a sensor identifier to identify the sensor.

The optical information training and generation method, performed by the computer of the optical information training and generation apparatus, may comprise setting a training spectral characteristic corresponding to the sensor identifier as a spectral characteristic.

The optical information training and generation method, performed by the computer of the optical information training and generation apparatus, may comprise training for information on optics with a two-dimensional image of a three-dimensional scene acquired by the sensor as teacher data.

The optical information training and generation method, performed by the computer of the optical information training and generation apparatus, may comprise outputting optical information to a latter part. The optical information training and generation method, performed by the computer of the optical information training and generation apparatus, may comprise outputting color values based on the optical information according to the training spectral characteristic.

### [Mode 10]

A program may cause a computer of an optical information training and generation apparatus to perform processing of receiving a sensor identifier to identify the sensor.

The program may cause the computer of the optical information training and generation apparatus to perform processing of setting a training spectral characteristic corresponding to the sensor identifier as a spectral characteristic.

The program may cause the computer of the optical information training and generation apparatus to perform processing of training for information on optics with a two-dimensional image of a three-dimensional scene acquired by the sensor as teacher data.

The program may cause the computer of the optical information training and generation apparatus to perform processing of outputting optical information to a latter part.

The program may cause the computer of the optical information training and generation apparatus to perform processing of outputting color values based on the optical information according to the training spectral characteristic. The above modes 9 and 10 can be expanded in the same way as mode 1 is expanded to modes 2 to 8.

The disclosure of each of the above PTLs is incorporated herein by reference thereto. Modifications and adjustments of the example embodiments or examples are possible within the scope of the overall disclosure (including the claims) of the present invention and based on the basic technical concept of the present invention. Various combinations or selections of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be construed to have been concretely disclosed.

In addition, as needed and based on the gist of the present invention, partial or entire use of the individual disclosed matters in the above literatures that have been referred to in combination with what is disclosed in the present application should be deemed to be included in what is disclosed in the present application, as part of the disclosure of the present invention.

### REFERENCE SIGNS LIST

10, 10A image generation system
100, 100A optical information training and generation apparatus
110 optical information training and inference part
111 density training and inference section
112 optical training and inference section
113 RGB-value output section
120 spectral characteristic conversion part
130 spectral characteristic setting part
140 sensor identifier input part
150 error detection part
160 wavelength output part
162 optical reflection output part
163 environmental light input part
164 environmental light calculation part
170 physical optics output part
200 rendering apparatus
300 two-dimensional camera (sensor)
310 second two-dimensional camera (sensor)
400 two-dimensional image display apparatus
500 observation viewpoint input apparatus of three-dimensional scene
1000 three-dimensional scene
9000 computer
9010 CPU
9020 communication interface
9030 memory
9040 auxiliary storage devices

What is claimed is:

1. An optical information training and generation apparatus, comprising:
at least a processor; and
a memory in circuit communication with the processor,
wherein the processor is configured to execute program instructions stored in the memory to perform:
training for information on optics with a two-dimensional image of a three-dimensional scene acquired by a sensor as teacher data;
receiving a sensor identifier to identify the sensor;
converting spectral characteristic;
setting a spectral characteristic in the converting spectral characteristic; wherein
the setting spectral characteristic comprises setting a training spectral characteristic corresponding to the sensor identifier in the converting spectral characteristic;
the training comprises outputting optical information to a latter part; and
the converting spectral characteristic comprises outputting color values based on the optical information according to the training spectral characteristic.

2. The optical information training and generation apparatus according to claim 1, wherein the processor is configured to execute the program instructions to perform:
converting the optical information into a wavelength vector; wherein
the converting spectral characteristic comprises outputting the color values based on the optical information by converting the wavelength vector outputted from the converting the optical information into the color values to output.

3. The optical information training and generation apparatus according to claim 1, wherein an observation azimuth and three-dimensional coordinates of the three-dimensional scene generated based on an imaging viewpoint for the two-dimensional image of the three-dimensional scene acquired by the sensor are inputted to the training;
wherein the processor is configured to execute the program instructions to implement: detecting an error between a two-dimensional image rendered using the color values outputted by the converting spectral characteristic based on the observation azimuth and the three-dimensional coordinates, and the two-dimensional image of the three-dimensional scene acquired by the sensor;
wherein the training comprises adjusting parameters of the training based on the error outputted by the detecting error to generate a trained model.

4. The optical information training and generation apparatus according to claim 3,
wherein
the setting spectral characteristic comprises setting an inference spectral characteristic in the converting spectral characteristic;
the trained model receives an observation azimuth and three-dimensional coordinates of the three-dimensional scene generated based on an inputted observation viewpoint of a user of the three-dimensional scene and outputs the optical information; and
the converting spectral characteristic comprises outputting color values based on the optical information according to the inference spectral characteristic.

5. The optical information training and generation apparatus according to claim 4,
wherein the setting spectral characteristic comprises setting an inference spectral characteristic among a plurality of inference spectral characteristics in the converting spectral characteristic.

6. The optical information training and generation apparatus according to claim 2,
wherein the converting the optical information comprises a conversion function of a light to an optical reflection model (BRDF (Bidirectional Reflectance Distribution Function)).

7. The optical information training and generation apparatus according to claim 2,
wherein the converting the optical information comprises inputting an environmental light and calculating an environmental light.

8. The optical information training and generation apparatus according to claim 1,
wherein the converting spectral characteristic comprises a training function and performs training for a sensor response characteristic of the sensor.

9. An optical information training and generation method, performed by a computer of an optical information training and generation apparatus, comprising:
receiving a sensor identifier to identify the sensor;
setting a training spectral characteristic corresponding to the sensor identifier as a spectral characteristic;
training for information on optics with a two-dimensional image of a three-dimensional scene acquired by the sensor as teacher data;
outputting optical information to a latter part; and
outputting color values based on the optical information according to the training spectral characteristic.

10. The optical information training and generation method according to claim 9, further comprising:
converting the optical information into a wavelength vector; wherein
the converting spectral characteristic comprises outputting the color values based on the optical information by converting the wavelength vector outputted from the converting the optical information into the color values to output.

11. The optical information training and generation method according to claim 9, wherein an observation azimuth and three-dimensional coordinates of the three-dimensional scene generated based on an imaging viewpoint for the two-dimensional image of the three-dimensional scene acquired by the sensor are inputted to the training;
further comprising detecting an error between a two-dimensional image rendered using the color values outputted by the converting spectral characteristic based on the observation azimuth and the three-dimensional coordinates, and the two-dimensional image of the three-dimensional scene acquired by the sensor;
wherein the training comprises adjusting parameters of the training based on the error outputted by the detecting error to generate a trained model.

12. The optical information training and generation method according to claim 11,
wherein
the setting spectral characteristic comprises setting an inference spectral characteristic in the converting spectral characteristic;
the trained model receives an observation azimuth and three-dimensional coordinates of the three-dimensional scene generated based on an inputted observation viewpoint of a user of the three-dimensional scene and outputs the optical information; and
the converting spectral characteristic comprises outputting color values based on the optical information according to the inference spectral characteristic.

13. The optical information training and generation method according to claim 12,
wherein the setting spectral characteristic comprises setting an inference spectral characteristic among a plurality of inference spectral characteristics in the converting spectral characteristic.

14. The optical information training and generation method according to claim 10,
wherein the converting the optical information comprises a conversion function of a light to an optical reflection model (BRDF (Bidirectional Reflectance Distribution Function)).

15. A computer-readable non-transitory recording medium recording a program, wherein the program causes a computer of an optical information training and generation apparatus to perform processing of:
receiving a sensor identifier to identify the sensor;
setting a training spectral characteristic corresponding to the sensor identifier as a spectral characteristic;
training for information on optics with a two-dimensional image of a three-dimensional scene acquired by the sensor as teacher data;
outputting optical information to a latter part; and
outputting color values based on the optical information according to the training spectral characteristic.

16. The medium according to claim 15, wherein the program further causes a computer to perform:
processing of converting the optical information into wavelength vector; wherein
the converting spectral characteristic comprises outputting the color values based on the optical information by converting the wavelength vector outputted from the converting the optical information into the color values to output.

17. The medium according to claim 15, wherein an observation azimuth and three-dimensional coordinates of the three-dimensional scene generated based on an imaging viewpoint for the two-dimensional image of the three-dimensional scene acquired by the sensor are inputted to the training;
wherein the program further causes a computer to perform:
detecting an error between a two-dimensional image rendered using the color values outputted by the converting spectral characteristic based on the observation azimuth and the three-dimensional coordinates, and the two-dimensional image of the three-dimensional scene acquired by the sensor;
wherein the training comprises adjusting parameters of the training based on the error outputted by the detecting error to generate a trained model.

18. The medium according to claim 17,
wherein
the setting spectral characteristic comprises setting an inference spectral characteristic in the converting spectral characteristic;
the trained model receives an observation azimuth and three-dimensional coordinates of the three-dimensional scene generated based on an inputted observation viewpoint of a user of the three-dimensional scene and outputs the optical information; and
the converting spectral characteristic comprises outputting color values based on the optical information according to the inference spectral characteristic.

19. The medium according to claim 18,
wherein the setting spectral characteristic comprises setting an inference spectral characteristic among a plurality of inference spectral characteristics in the converting spectral characteristic.

20. The medium according to claim 16,
wherein the converting the optical information comprises a conversion function of a light to an optical reflection model (BRDF (Bidirectional Reflectance Distribution Function)).
